(19) United States
(12) Patent Application Publication
(10) Pub. No.: US 2025/0360512 A1
(43) Pub. Date: Nov. 27, 2025

(54) LIFTING DEVICE

(71) Applicant: SANDVIK LTD, Dungannon (GB)

(72) Inventors: Stuart GRAYDON, Dungannon (GB); Stuart SMYTH, Dungannon (GB); Adam BAXTER, Dungannon (GB)

(21) Appl. No.: 18/874,905

(22) PCT Filed: Jun. 21, 2023
(86) PCT No.: PCT/EP2023/066715

§ 371 Date: Dec. 13, 2024

(30) Foreign Application Priority Data
Jun. 21, 2022 (EP) 22180045.1

(51) Int. Cl. B02C 23/00; B02C 1/04

(52) U.S. Cl. CPC B02C 23/00; B02C 1/04

(57) ABSTRACT

A lifting device is configured to be integratable into a jaw crusher for facilitating access to items to be lifted from above during machine servicing. The crusher includes a crusher frame generally made up of oppositely disposed sidewalls and supporting a fixed jaw and a movable jaw defining a crushing chamber for material to be crushed. The lifting device has at least one primary pulley mountable on the jaw crusher above an item to be lifted and configured for lifting a toggle plate for a jaw crusher, wherein the lifting device is configurable to lift the item in a straight lift.

### FIELD OF INVENTION

This invention relates to a lifting device and more particularly to a lifting device integratable into a jaw crusher for lifting items.

### BACKGROUND OF THE INVENTION

A variety of different crushers have evolved for processing bulk material such as stone, minerals and both domestic and industrial waste including construction materials to generate a crushed product for subsequent processing or disposal.

Jaw crushers are generally made up of a fixed jaw and a movable jaw mounted in a crusher frame in which the movable jaw is movable relative to the fixed jaw to generate an impelling force to crush material in a crushing chamber defined between the two jaws. The jaw crusher includes a cross beam in the crusher frame and a toggle plate clamped between the cross beam and the movable jaw. A hydraulic system applies a load to the cross beam, which is transmitted to the movable jaw via the toggle plate to resist the forces generated during crushing. Jaw crushers can be mobile or stationary crushers where the mobile crushers are provided with a wheeled or tracked chassis and the stationary crushers are provided with a stationary crusher mainframe.

Jaw crushers require regular maintenance and service and, due to the forces to which the jaw crusher is subjected during use, components of the jaw crusher sometimes require assembly, disassembly, replacement or removal for servicing e.g. worn or damaged toggle plates may require removal and replacement (typically after 3,000 to 4,000 hours of use). Due to the configuration of jaw crushers, such items must generally be manually removed and replaced from below and require at least two operatives to perform the operation. However, toggle plates and other jaw crusher components can be extremely heavy and cumbersome (e.g. toggle plates typically have a weight of about 100 kg) with the result that the need to manually handle the items from below can present significant health and safety risks to personnel.

Known jaw crushers are also equipped with hydraulic systems, powered by the jaw crusher motor, to effect movement of the movable jaw and to clamp a toggle plate between the movable jaw and the cross beam. Accordingly, in order to make the toggle plate available for removal, the jaw crusher motor is activated to lock open the movable jaw and is then switched off to allow manual access to the toggle plate. Once the motor is switched off, the hydraulic fluid is returned through the hydraulic system under gravity resulting in closure of the movable jaw. This can also present a safety hazard to service personnel and reduce the time available to effect removal of the toggle plate.

### SUMMARY OF THE INVENTION

An object of the invention is to provide a lifting device to assist in the servicing of a jaw crusher to minimise health and safety risks. A further object of the invention is to provide a hydraulic system for a jaw crusher configured to effect movement of the movable jaw independently of the jaw crusher motor. Thereby potential safety hazards associated with closure of the movable jaw may be avoided and available time to effect removal of the toggle plate may be prolonged. These and other objects have been achieved by the configuration(s) set forth in the appended independent claims.

In one aspect of the invention there is provided a lifting device configured to be integratable into a jaw crusher comprising a crusher frame supporting a fixed jaw and a movable jaw defining a crushing chamber for material to be crushed, the lifting device comprising:
a primary pulley mountable on a jaw crusher above an item to be lifted and configurable to lift the item in a straight lift. The lifting device facilitates access to heavy items such as toggle plates from above to facilitate safe and easy access during machine servicing.

In one embodiment, the primary pulley is mountable on the crusher frame. This allows for a mechanical advantage when lifting.

In any embodiment, the primary pulley is mountable on the fixed jaw or the movable jaw. This allows the primary pulley to be located as required for lifting

In any embodiment, the lifting device further comprises a secondary pulley mountable on a jaw crusher below the primary pulley. This assists in facilitating an accurate straight lift.

In any embodiment, the secondary pulley is mountable on the crusher frame. This also provides a mechanical advantage and targeted lifting.

In any embodiment, the secondary pulley is mountable on the fixed jaw or the movable jaw. This allows the items requiring lifting to be targeted as required.

In any embodiment, the primary pulley and/or the secondary pulley are pivotably mountable on the jaw crusher. This allows a lifting cable to be directed towards items to be lifted.

In one embodiment, the lifting device further comprises a winch mountable on a jaw crusher. The winch assists in lifting items.

Optionally, the winch is a manually operated winch or an electrically powered winch. Such winches increase the lifting force.

In one embodiment, the electrically powered winch is remotely operable. Personnel can therefore control lifting at a safe distance from heavy items.

The invention also extends to a jaw crusher comprising the lifting device as hereinbefore defined.

In any embodiment, the jaw crusher comprises:
a motor providing a primary power source to a primary hydraulic pump of the jaw crusher;
a crusher frame supporting a fixed jaw and a movable jaw defining a crushing chamber;
a cross beam transversely mounted in the crusher frame;
a toggle plate extending between the cross beam and the movable jaw, and
a hydraulic system having a primary pump line powered by the primary hydraulic pump for moving the movable jaw and clamping the toggle plate;
wherein the hydraulic system comprises an auxiliary pump powered independently of the primary pump for effecting movement of the movable jaw. The movable jaw can therefore be powered open to remain open as required without requiring operation of the motor to improve safety during maintenance operations.

Suitably, the auxiliary pump comprises a battery powered auxiliary pump. The auxiliary pump does not therefore require power via the motor.

In any embodiment, the battery powered auxiliary pump is a 24V maintenance pump.

In one embodiment, the auxiliary pump is in an accumulator block on the crusher frame. This ensures a faster response time for shock attenuation and a reduction in hydraulic hammer.

Suitably, the accumulator block comprises a shut-off valve to isolate the hydraulic system from the auxiliary pump as required. This prevents fluid from returning to tank during operation of the auxiliary pump.

The invention also extends to a jaw crusher comprising:
a motor providing a primary power source to a primary hydraulic pump of the jaw crusher;
a crusher frame supporting a fixed jaw and a movable jaw defining a crushing chamber;
a cross beam transversely mounted in the crusher frame;
a toggle plate extending between the cross beam and the movable jaw, and
a hydraulic system having a primary pump line powered by the primary hydraulic pump for moving the movable jaw and clamping the toggle plate;
wherein the hydraulic system comprises an auxiliary pump powered independently of the primary pump for effecting movement of the movable jaw. The movable jaw can therefore be powered open to remain open as required without requiring operation of the motor to improve safety during maintenance operations.

Suitably, the auxiliary pump comprises a battery powered auxiliary pump. The auxiliary pump does not therefore require power via the motor.

In any embodiment, the battery powered auxiliary pump is a 24V maintenance pump.

In one embodiment, the auxiliary pump is in an accumulator block on the crusher frame. This ensures a faster response time for shock attenuation and a reduction in hydraulic hammer.

Suitably, the accumulator block comprises a shut-off valve to isolate the hydraulic system from the auxiliary pump as required. This prevents fluid from returning to tank during operation of the auxiliary pump.

### BRIEF DESCRIPTION OF THE DRAWINGS

The invention will now be described, by way of example only, with reference to the accompanying drawings in which:

FIG. 1 is a perspective view from above and one side of a mobile jaw crusher of the invention fitted with a first embodiment of an integrated lifting device of the invention in which the lifting device is made up of a primary pulley on the crusher frame and an electric winch also on the crusher frame and the mobile jaw crusher has a working platform to allow safe use of the lifting device to access items from above;

FIG. 2 is an enlarged isometric rear view of the jaw crusher of the mobile jaw crusher of FIG. 1 with the primary pulley and electric winch on the crusher frame and the secondary pulley disposed below the primary pulley on the movable jaw;

FIG. 3 is a cross-sectional view of the crusher frame of FIG. 2 with a lifting cable extending from the winch through the primary and secondary pulleys;

FIG. 4 is a cross-sectional view as shown in FIG. 3 but with an item such as a toggle plate being lifted by the lifting device;

FIG. 5 is an isometric rear view of a crusher frame fitted with a second embodiment of a lifting device of the invention in which the lifting device has an electric winch lifting device configuration as described in FIGS. 1 to 4 and a manual winch lifting device configuration either side of the electric winch configuration with associated secondary angled pulleys for the manual winch configuration on the crusher frame sidewalls;

FIG. 6 is a cross-sectional view through the crusher frame of FIG. 5 with the manual winch secured to the mainframe in a non-lifting position;

FIG. 7 is an isometric view of the lifting device of FIG. 4 separated from the crusher frame for clarity;

FIG. 8 is a plan view from above of the lifting device of FIG. 7;

FIG. 9 is a cross-sectional view through a crusher frame fitted with a third embodiment of the invention similar to the embodiment of FIG. 5 but in which a manual winch is secured to the chassis instead of the mainframe in the non-lifting position, and

FIG. 10 is an enlarged view of an accumulator block with auxiliary pump of the hydraulic system of the jaw crusher of FIGS. 1 to 9.

### DETAILED DESCRIPTION OF THE INVENTION

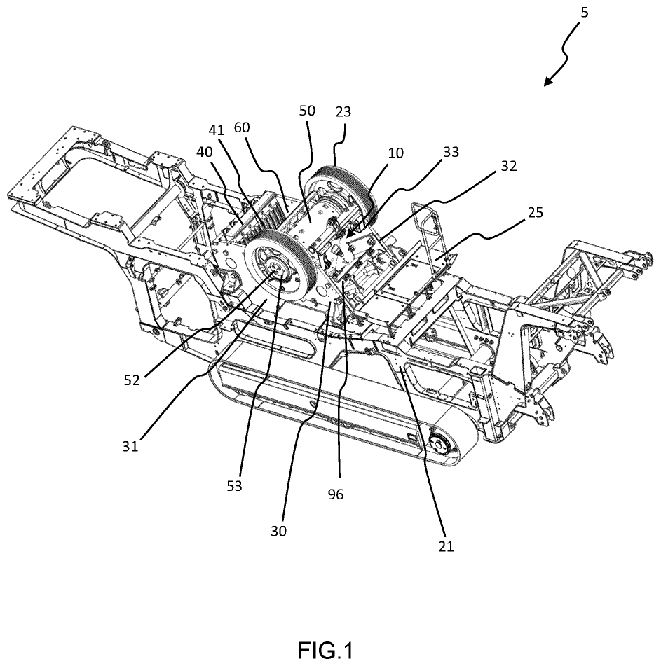

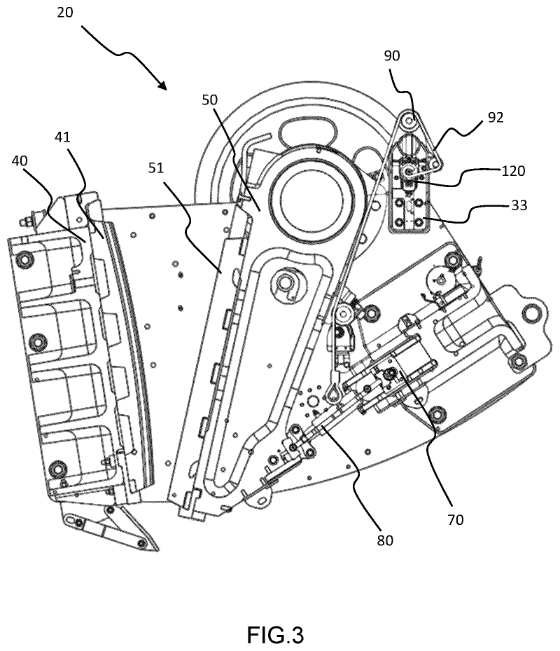

FIG. 1 shows a lifting device 10 of the invention integrated into a jaw crusher 20. As shown in the drawing, the jaw crusher 20 can be mounted to a mobile jaw crusher 5 having a chassis 21 with a crusher frame 30 in which is mounted a fixed jaw 40 and an opposite movable jaw 50 which together define a crushing chamber 60 for material to be crushed. The crusher frame 30 is generally made up of two oppositely disposed sidewalls 31,32 between which the jaws 40,50 are mounted. The crusher frame 30 is also provided with a lifting device crossbeam 33 which extends between the sidewalls 31,32 to the rear of the movable jaw 32. The jaws 40,50 are each provided with respective wear plates 41,51. An upper end of the movable jaw 50 is connected to an eccentric shaft 52 rotatably received in a bearing 53 so that rotation of the eccentric shaft 52 causes circular motion of the upper end of the movable jaw 50 towards the fixed jaw 40 to generate the impelling force to crush materials in the crushing chamber 60. The inertia required to crush material fed to the jaw crusher 20 is provided by a weighted flywheel 23 operable to move the eccentric jaw crusher shaft 52 on which the movable jaw 50 is mounted. A jaw crusher motor is operative for rotating the flywheel 23 by means of a transmission belt. As will be appreciated by those skilled in the art, the jaw crusher 20 typically comprises a toggle plate crossbeam 70 and a toggle plate 80 arranged at the lower end of the movable jaw 50 (see also FIG. 3). Toggle plate cylinders are operative to clamp the toggle plate between the toggle plate cross beam and the movable jaw. The toggle plate 80 is an extremely heavy item requiring regular servicing or replacement. The jaw crusher 20 further comprises a hydraulic system which will be familiar to those skilled in the art for moving and positioning the movable jaw 50 to a desired position e.g. to a desired closed side setting (CSS) (the shortest distance between the wear plate 41 of the fixed jaw 40 and the wear plate 51 of the movable jaw 50) or another position. The lifting device 10 of the invention, which can be built-in or integrated into the jaw crusher 20 during manufacture of the jaw crusher 20 or retrofitted to an existing jaw crusher 20, is configured to be mounted on the jaw crusher 20 above items to be lifted, e.g. toggle plates 80, so that items can be lifted from above in a straight lift. Accordingly, the lifting device 10 of the invention obviates the need to manually handle heavy items from below thus improving personnel safety. More particularly, as shown in FIG. 1 the mobile jaw crusher 5 can be provided with a working platform 25 on the chassis 21 adjacent the lifting device 10 so that the lifting device 10 can be safely operated to lift items located below the lifting device 10 and the working platform 25.

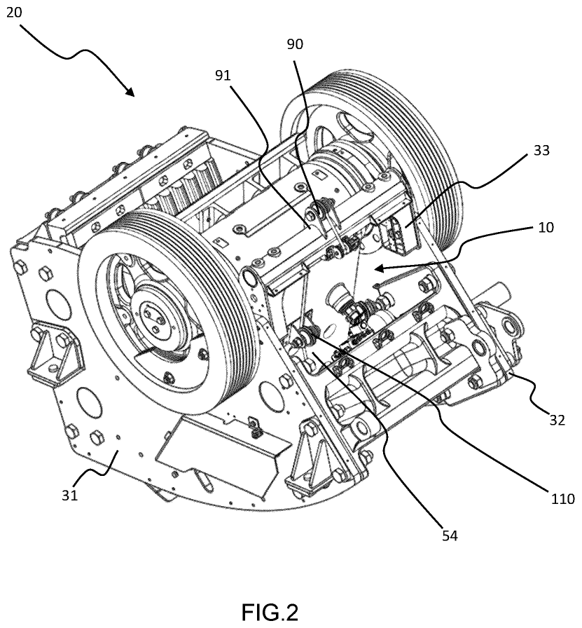

FIGS. 2 and 3 show enlarged views of the lifting device 10 of FIG. 1 with a lifting cable 92 for lifting items with the lifting device 10 extending through the lifting device 10 in FIG. 3. As shown in the drawings, the lifting device 10 is made up of a primary pulley 90 centrally mounted on the lifting device crossbeam 33. The lifting device 10 is generally configured and mounted on the movable jaw 50 to provide particular ease of access to an item to be lifted for lifting purposes. However, as shall be explained in more detail below, the lifting device 10 or elements of the lifting device 10 can also be mounted on the fixed jaw 40 or the crusher frame 30 if desired or required.

More particularly, in the present embodiment, as indicated above, the primary pulley 90 is mounted on the lifting device crossbeam 33 at a primary pulley mounting 91. Mounting of the winch 120 on the crossbeam 33 provides a mechanical advantage to the lifting device 10 in use. The primary pulley mounting 91 can also be a pivotable mounting 91 if desired to assist in the targeted lifting of items to be lifted such as a toggle plate. In order to further ensure a completely straight lift of a toggle plate or other items, the lifting device 10 of the invention can include a secondary guide pulley 110 which in the present embodiment is mounted on a rear wall 54 of the movable jaw 50 immediately beneath the primary pulley 90. In general, as in the present embodiment, the primary pulley 90 is positioned uppermost in the lifting device and any secondary guide pulley 110 is positioned beneath the primary pulley 90 directly above the item to be lifted to optimise a straight lift.

As has been explained hereinbefore and as is derivable from the drawings, the lifting device crossbeam 33 is arranged at a rear wall 54 of the movable jaw. Thus, the lifting device crossbeam 33 is configured accordingly. The crossbeam 33 comprises opposite end portions respectively configured to be mounted to a sidewall 31, 32 of the crusher frame such that the crossbeam extends between the sidewalls 31, 32. At least one primary pulley 90 is mounted on top of the lifting device crossbeam 33. Thus, the primary pulley 90 is configured accordingly.

The lifting device crossbeam 33 is arranged at a position in the crusher that is above the toggle plate 80 and above the toggle beam 70, thus the crossbeam 33 is configured accordingly.

The toggle plate 80 is clamped between the toggle beam 70 and the rear wall of the movable jaw.

At least one secondary pully is mounted to the rear wall 54 of the movable jaw at a position immediately above toggle plate 80. Thus, the secondary pulley is configured accordingly.

In the present embodiment, the lifting device 10 includes an optional winch 120 to effect the lifting action. However, as will be appreciated by those skilled in the art, the lifting device 10 can also be operated without a winch 120 by simply manually drawing on a cable 92 extending through the primary pulley 90. The winch 120 is mounted on the crossbeam 33 beneath the primary pulley 90 and is electrically powered (e.g. via the jaw crusher motor driven primary power source or by a separate independent power source such as a 24V battery). The winch 120 can be electronically controlled so that the lifting device 10 can be operated remotely to further improve personnel safety. As discussed further below, in other embodiments of the invention, the winch 120 can be a manually operated winch if desired.

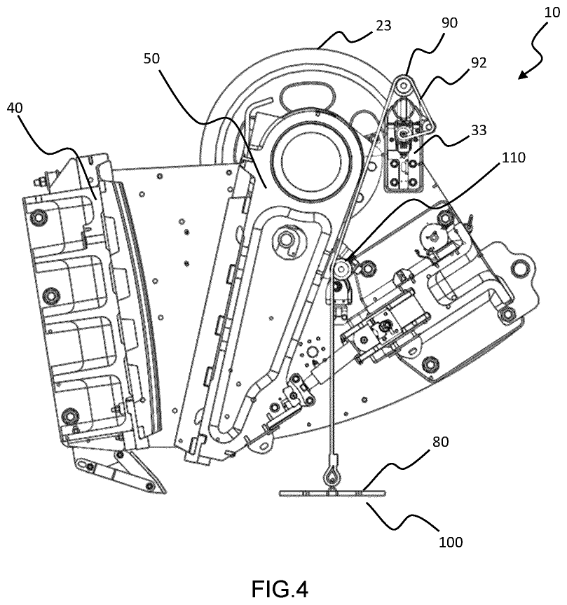

FIG. 4 shows the lifting device 10 of FIGS. 1 to 3 in use. As shown in the drawing, an item to be lifted 100, such as a toggle plate 80 can be accessed and lifted using the primary pulley 90, the secondary pulley 110 and the electric winch 120 in a straight line lift from above (e.g. by personnel on the working platform 25 of FIG. 1).

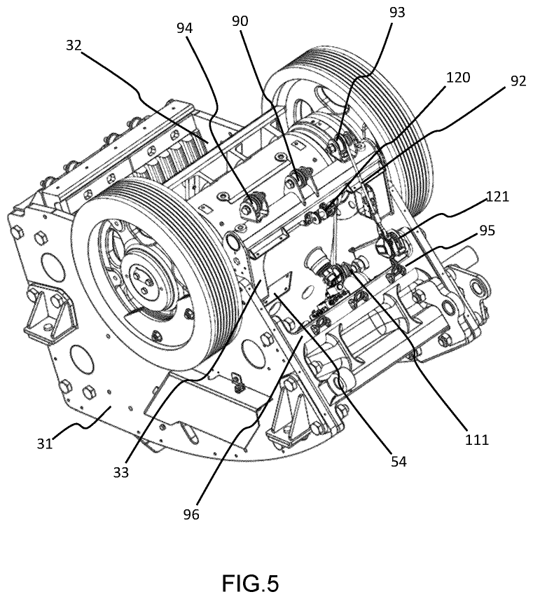

FIGS. 5 to 8 show a second embodiment of the invention in which the lifting device 10 includes multiple primary pulleys 90, 93 and 94, multiple associated secondary pulleys 110, 111 and 112, an electric winch 120 and a manually operated winch 121.

A second primary pulley 93 is mounted on the crossbeam 33 between the first primary pulley 90 and the crusher frame sidewall 32. The second primary pulley 93 is pivotably mounted on the crossbeam 33 to facilitate accurate targeting of items to be lifted and a cable 92 extends from the second primary pulley 93 to a second secondary pulley 111 mounted on the sidewall 32 of the crusher frame 30. The cable 92 can be operated by a manual winch 121 located adjacent the second secondary pulley 111. Similarly, a third primary pulley 94 is mounted on the crossbeam 33 between the first primary pulley 90 and the crusher frame sidewall 31. The third primary pulley 94 is pivotably mounted on the crossbeam 33 to facilitate accurate targeting of items to be lifted and a cable 92 extends from the third primary pulley 94 to a third secondary pulley 112 mounted on the sidewall 31 of the crusher frame 30.

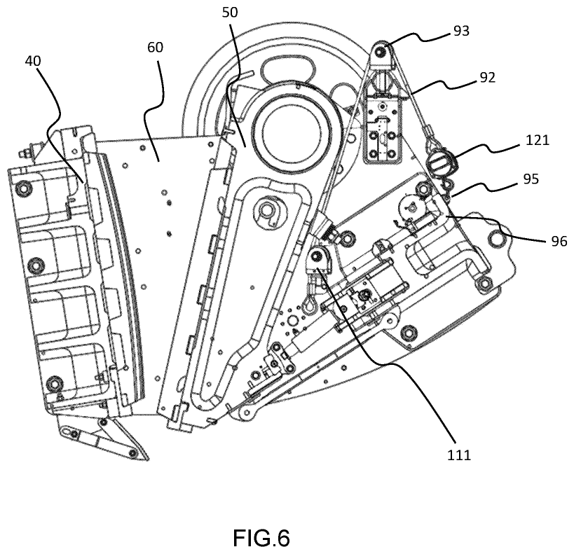

The cables 92 employed with the lifting device 10 can be secured to the jaw crusher 20 at various pick-up points 95 provided on a pick up arm 96 also extending between the crusher frame sidewalls 31,32. In the present embodiment, three spaced apart pick-up points 95 are provided on the pick up arm 96 corresponding with each primary pulley 90,93 and 94. FIG. 6 shows a cross-sectional view through the crusher frame 30 of FIG. 5 with the manual winch 121 secured to a pickup point 95 on the pickup arm 96 of the crusher frame 30 in a non-lifting position.

It will be appreciated by those skilled in the art that in other embodiments the lifting device 10 can be configured to be individually made up of the lifting device 10 as described in FIGS. 1 to 4, the second primary pulley 93 (and associated optional second secondary pulley 111 and manual winch 121) and/or the third primary pulley 94 (and associated third secondary pulley 112) or any combination of the above configurations with additional or fewer primary and secondary pulleys or winches as required.

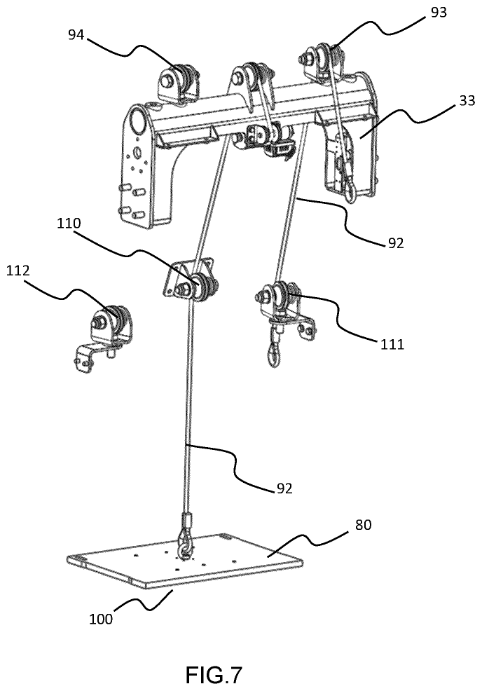

FIG. 7 shows the lifting device 10 of FIG. 5 with a toggle plate being lifted by the cable 92 extending through the central first primary pulley 90 of the lifting device.

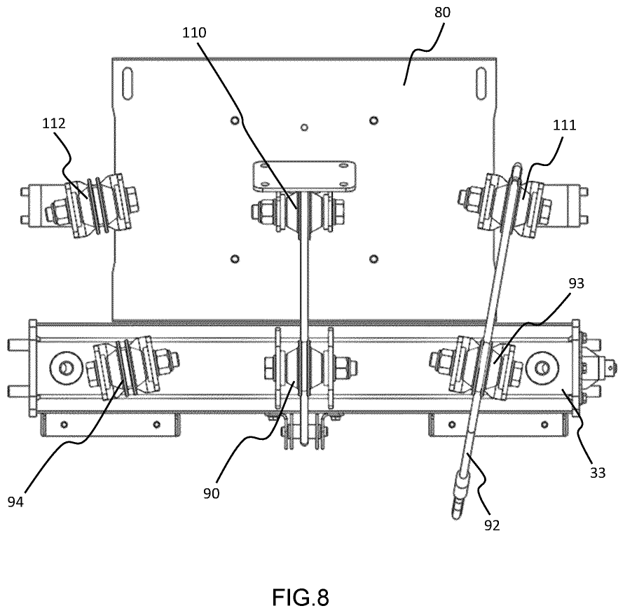

FIG. 8 shows a plan view from above of the lifting device 10 of FIGS. 5 and 6 to illustrate that the second primary pulley 93 and third primary pulley 94 are pivotably mounted on the crossbeam 33 to accurately direct the cable towards the items to be lifted below.

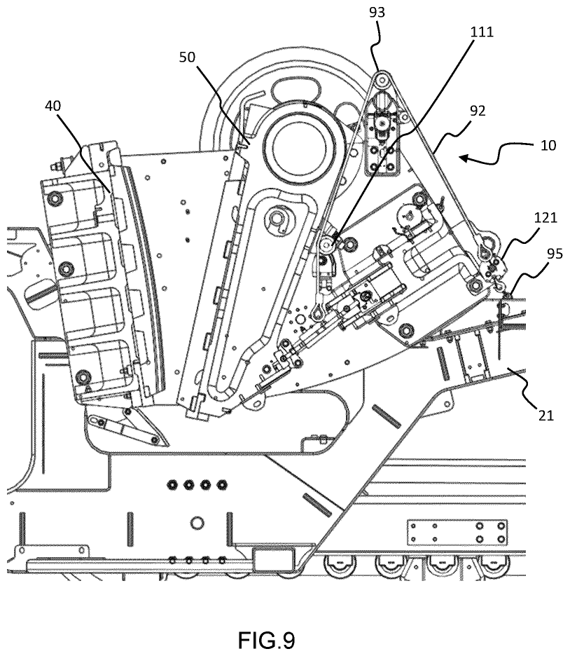

FIG. 9 is a cross-sectional view through a crusher frame fitted with a third embodiment of the invention similar to the embodiment of FIGS. 5 and 6 but in which a manual winch is secured to the chassis 21, pick up point 95, instead of the mainframe in the non-lifting position

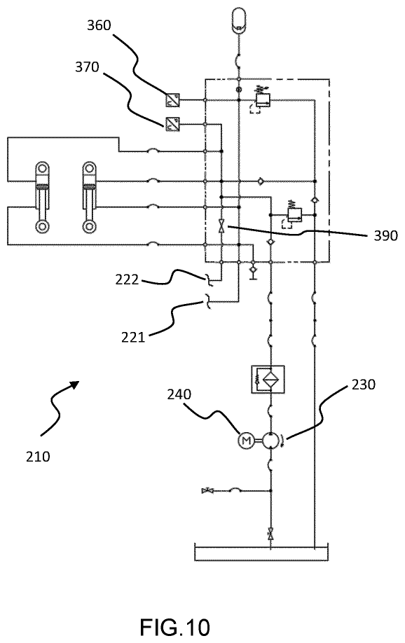

FIG. 10 shows an accumulator block 210 of the hydraulic system of the jaw crusher 20 in which the accumulator block 210 is provided with an auxiliary pump 230 powered independently of the hydraulic system primary pump for effecting movement of the movable jaw 50 during service operations so that the service operations can be performed without requiring activation of the jaw crusher motor which is required to provide power to the hydraulic system primary pump. The auxiliary pump 230 can be a battery powered auxiliary pump 240 such as a 24V maintenance pump. A conventional hydraulic system with no accumulator block 210/auxiliary pump 230 will be familiar to those skilled in the art in which an hydraulic system primary pump is in fluid communication with a primary pump line 221 for effecting toggle cylinder closure.

As shown in the drawing, the auxiliary pump 230 is also in fluid communication with a second primary pump line 222 which effects opening of the toggle plate cylinders independently of the first primary pump line 221 powered by the primary pump i.e.

urges the toggle plate cylinder pistons away from the toggle plate so that the toggle plate is released and can “fall out”. As a result, unlike the known operation of the movable jaw 50 in known jaw crushers, the toggle plate can be removed and the movable jaw 50 can be powered open without requiring motor operation. As shown in the drawing, the accumulator block 210 is also provided with an accumulator pressure transducer 360 and a toggle cylinder pressure transducer 370. Within the accumulator block 210 is also provided a shut-off valve 390 to isolate the hydraulic system 210 from the auxiliary pump 230 as required and prevent fluid from returning to tank during operation of the auxiliary pump 230. The shut-off valve 390 is opened once service operations are complete to allow fluid flow during normal operation so that the toggle plate cylinder pistons to close under gravity after the shutoff valve 390 is opened i.e. trapped energy is dissipated so that fluid goes back to tank while the pressure transducer 370 can detect if the shutoff valve 390 is open or closed. However, when using the primary hydraulic pump, the cylinders can be powered open and closed (toggle plate clamped for crushing operations) via the hydraulic system. In short, with the auxiliary pump 230, the movable jaw 50 can be maintained open as required and does not close as a result of the return of hydraulic fluid through the primary pump line 221 when the motor is powered off. This results in significant improvements in safety for operatives performing service and maintenance operations. If desired, a turnbuckle can also be installed at the movable jaw during service operations such as toggle plate removal to further assist in maintaining the movable jaw 50 in a fixed position for enhanced safety. A further optional safety enhancement is that the shutoff valve 390 could be part of a lock out tag out safety procedure.

The accumulator block 210 can be located on the crusher frame 50 to ensure a faster response time for shock attenuation and a reduction in hydraulic hammer.

### ITEMS

Item 1. A lifting device 10 configured to be integratable into a jaw crusher 20 comprising a crusher frame 30 supporting a fixed jaw 40 and a movable jaw 50 defining a crushing chamber 60 for material to be crushed, the lifting device 10 comprising:

a primary pulley 90, 93, 94 mountable on a jaw crusher 20 above an item 100 to be lifted and configurable to lift the item 100 in a straight lift.

Item 2. A lifting device 10 as in item 1 wherein the primary pulley 90, 93, 94 is mountable on the crusher frame 30.

Item 3. A lifting device 10 as in item 1 wherein the primary pulley 90, 93, 94 is mountable on the fixed jaw 40 or the movable jaw 50.

Item 4. A lifting device 10 as in any of items 1 to 3 further comprising a secondary pulley 110 mountable on a jaw crusher 20 below the primary pulley 90.

Item 5. A lifting device 10 as in item 4 wherein the secondary pulley 110, 111, 112 is mountable on the crusher frame 30.

Item 6. A lifting device 10 as in item 4 or item 5 wherein the secondary pulley 110, 111, 112 is mountable on the fixed jaw 40 or the movable jaw 50.

Item 7. A lifting device 10 as in any of items 1 to 6 wherein the primary pulley 90, 93, 94 and/or the secondary pulley 110, 111, 112 are pivotably mountable on the jaw crusher 20.

Item 8. A lifting device 10 as in any of items 1 to 7 wherein the lifting device 10 further comprises a winch 120 mountable on a jaw crusher 20.

Item 9. A lifting device 10 as in item 8 wherein the winch 120 is a manually operated winch 121 or an electrically powered winch 120.

Item 10. A lifting device 10 as in item 11 wherein the electrically powered winch 120 is remotely operable.

Item 11. A jaw crusher 20 comprising a lifting device 10 as in any of items 1 to 10.

Item 12. A jaw crusher 20 as in item 11 wherein the jaw crusher 20 comprises
a motor providing a primary power source to a primary hydraulic pump of the jaw crusher 20;
a crusher frame 30 supporting a fixed jaw 40 and a movable jaw 50 defining a crushing chamber 60;
a cross beam 70 transversely mounted in the crusher frame 50;
a toggle plate 80 extending between the cross beam 70 and the movable jaw 50, and
a hydraulic system having a primary pump line 221 powered by the primary hydraulic pump for moving the movable jaw 50 and clamping the toggle plate 80;
wherein the hydraulic system comprises an auxiliary pump 230 powered independently of the primary pump for effecting movement of the movable jaw 50.

Item 13. A jaw crusher 20 as in item 12 wherein the auxiliary pump 230 comprises a battery powered auxiliary pump 240 e.g. a 24V maintenance pump.

Item 14. A jaw crusher 20 as in item 12 or item 13 wherein the auxiliary pump 230 is in an accumulator block 210 on the crusher frame 30.

Item 15. A jaw crusher 20 as claimed in item 14 wherein the accumulator block 210 comprises a shut-off valve 390 to isolate the hydraulic system from the auxiliary pump 230 as required.

1. A lifting device configured to be integratable into a jaw crusher for facilitating access to items to be lifted from above during machine servicing, the crusher including a crusher frame including oppositely disposed sidewalls and supporting a fixed jaw and a movable jaw defining a crushing chamber for material to be crushed, the lifting device comprising:
at least one primary pulley mountable on the jaw crusher above an item to be lifted and configured for lifting a toggle plate for a jaw crusher, wherein the lifting device is configurable to lift the item in a straight lift.

2. The lifting device according to claim 1, further comprising a lifting device crossbeam arranged for mounting to the crusher sidewalls such as to extend there between, and wherein the at least one primary pulley is mountable to one of the crusher frame and the lifting device crossbeam.

3. The lifting device according to claim 1, further comprising a lifting cable configured to extend through the lifting device and for lifting the toggle plate with the lifting device.

4. The lifting device according to claim 1, wherein the primary pulley is mountable on the crusher frame.

5. The lifting device according to claim 1, wherein the primary pulley is mountable on the fixed jaw or the movable jaw.

6. The lifting device according to claim 1, further comprising a secondary pulley mountable on the jaw crusher below the primary pulley.

7. The lifting device according to claim 6, wherein the secondary pulley is mountable on the crusher frame.

8. The lifting device according to claim 6, wherein the secondary pulley is mountable on the fixed jaw or the movable jaw.

9. The lifting device according to claim 1, wherein the primary pulley and/or the secondary pulley are pivotably mountable on the jaw crusher.

10. The lifting device according to claim 1, further comprising a winch mountable on the jaw crusher.

11. The lifting device according to claim 10, wherein the winch is a manually operated winch or an electrically powered winch.

12. The lifting device according to claim 11, wherein the electrically powered winch is remotely operable.

13. A jaw crusher comprising a lifting device according to claim 1.

14. The jaw crusher according to claim 13, further comprising:
a motor providing a primary power source to a primary hydraulic pump of the jaw crusher;
a crusher frame supporting a fixed jaw and a movable jaw defining a crushing chamber;
a toggle plate cross beam transversely mounted in the crusher frame;
a toggle plate extending between the toggle plate cross beam and the movable jaw; and
a hydraulic system having a primary pump line powered by the primary hydraulic pump for moving the movable jaw and clamping the toggle plate, wherein the hydraulic system includes an auxiliary pump powered independently of the primary pump for effecting movement of the movable jaw .

15. The jaw crusher according to claim 14, wherein the auxiliary pump comprises a battery powered auxiliary pump.

16. The jaw crusher according to claim 14, wherein the auxiliary pump is in an accumulator block on the crusher frame.

17. The jaw crusher according to claim 16, wherein the accumulator block includes a shut-off valve arranged to isolate the hydraulic system from the auxiliary pump as required.
